(19) United States
(12) Patent Application Publication
(10) Pub. No.: US 2026/0368548 A1
(43) Pub. Date: Nov. 19, 2026

(54) LEVERAGING TREE STRUCTURES TO ENABLE LONG-RANGE, NON-LOCAL INTERACTIONS IN STATE SPACE MODELS

(71) Applicant: QUALCOMM Incorporated, San Diego, CA (US)

(72) Inventors: Evgenii EGOROV, Amstelveen (NL); Hanno ACKERMANN, Amsterdam (NL); Markus NAGEL, Amsterdam (NL); Hong CAI, San Diego, CA (US)

(21) Appl. No.: 19/422,156

(22) Filed: Dec. 16, 2025

Related U.S. Application Data
(60) Provisional application No. 63/806,157, filed on May 15, 2025.

(51) Int. Cl. G06N 5/01

(52) U.S. Cl. CPC G06N 5/01

(57) ABSTRACT

Certain aspects of the present disclosure provide techniques and apparatus for machine learning. An example method generally includes scanning an input to generate a sequence of tensors representing features of the input; effectively accessing a tree matrix representing a trained tree structure corresponding to the sequence of tensors, the tree structure including at least two hierarchical levels; effectively matrix multiplying an inverse of the tree matrix with the sequence of tensors to generate state variables according to a state space model; processing the state variables; and taking one or more actions based on the processed state variables.

### CROSS-REFERENCE TO RELATED APPLICATION(S)

The present application for patent claims the benefit of and priority to U.S. Provisional Patent Appl. No. 63/806,157, filed May 15, 2025, which is hereby incorporated by reference herein in its entirety for all applicable purposes.

### INTRODUCTION

Aspects of the present disclosure relate to machine learning, and more specifically, to generating and using a hierarchical tree structure to introduce interactions between more elements in a state space model.

Machine learning models, such as convolutional neural networks, transformer neural networks, and the like, are used for various tasks, such as object detection in visual content, segmentation of visual content, processing data having objects with different dimensions, generating natural language responses to natural language queries, and the like. In order to perform these tasks, these machine learning models may be trained to perform various operations internally (e.g., to map input data into representations in a latent space based on which an inference can be performed, to project inputs into tokens (e.g., key, query, and value tokens in a transformer neural network), apply an activation function to data generated by the machine learning model, etc.). These operations may vary in complexity, from relatively simple mathematical operations (e.g., addition, multiplication, etc.) to more complex mathematical operations that involve significant amounts of processor time and memory utilization.

### BRIEF SUMMARY

Certain aspects of the present disclosure provide a processor-implemented method for machine learning. The method generally includes scanning an input to generate a sequence of tensors representing features of the input; effectively accessing a tree matrix representing a trained tree structure corresponding to the sequence of tensors, the tree structure including at least two hierarchical levels; effectively matrix multiplying an inverse of the tree matrix with the sequence of tensors to generate state variables according to a state space model; processing the state variables; and taking one or more actions based on the processed state variables.

Certain aspects of the present disclosure provide a processing system. The processing system generally includes at least one memory comprising computer-executable instructions and one or more processors coupled to the at least one memory. The one or more processors are collectively configured to execute the computer-executable instructions and cause the processing system to: scan an input to generate a sequence of tensors representing features of the input; effectively access a tree matrix representing a trained tree structure corresponding to the sequence of tensors, the tree structure including at least two hierarchical levels; effectively matrix multiply an inverse of the tree matrix with the sequence of tensors to generate state variables according to a state space model; process the state variables; and take one or more actions based on the processed state variables.

Certain aspects of the present disclosure provide a processing system. The processing system generally includes means for scanning an input to generate a sequence of tensors representing features of the input; means for effectively accessing a tree matrix representing a trained tree structure corresponding to the sequence of tensors, the tree structure including at least two hierarchical levels; means for effectively matrix multiplying an inverse of the tree matrix with the sequence of tensors to generate state variables according to a state space model; means for processing the state variables; and means for taking one or more actions based on the processed state variables.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates an example pipeline for converting an input object into a sequence of elements for processing using a state space model, according to certain aspects of the present disclosure.

FIG. 2 illustrates an example equation, an example process visualization, and representative matrices for state space models, according to certain aspects of the present disclosure.

FIG. 3A illustrates an example sparse tree-structured matrix, according to certain aspects of the present disclosure.

FIG. 3B illustrates an example dense inverse of the tree-structured matrix of FIG. 3A, according to certain aspects of the present disclosure.

FIG. 4 illustrates generating a tree structure by assigning subsets of elements of an input object into meta-nodes and assigning subsets of meta-nodes into higher-level meta-nodes, according to certain aspects of the present disclosure.

FIG. 5 illustrates different alternative shapes for the meta-nodes of FIG. 4, according to certain aspects of the present disclosure.

FIG. 6 illustrates an example pipeline for generating a tree structure using virtual nodes, according to certain aspects of the present disclosure.

FIG. 7 illustrates an example tree structure using quadtrees with virtual nodes, according to certain aspects of the present disclosure.

FIG. 8 illustrates an example pipeline for generating a tree structure by grouping and arranging elements into multiple levels, according to certain aspects of the present disclosure.

FIG. 9 illustrates an example sparse tree matrix T with various terms representing different interactions between nodes of the tree structure, where the dense inverse of matrix T is used to convert from input feature variables to state space model variables, according to certain aspects of the present disclosure.

FIG. 10 illustrates example matrices for a forward pass through the tree structure, according to certain aspects of the present disclosure.

FIG. 11 illustrates an example forward pass through the tree structure from leaf nodes to a root node with the example matrices of FIG. 10, according to certain aspects of the present disclosure.

FIG. 12 illustrates an example forward pass through the tree structure from the root node to the leaf nodes with the example matrices of FIG. 10, according to certain aspects of the present disclosure.

FIG. 13 illustrates an example backward pass through the tree structure, according to certain aspects of the present disclosure.

FIG. 14 is a flow diagram of example operations for machine learning, according to certain aspects of the present disclosure.

FIG. 15 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Certain aspects of the present disclosure provide apparatuses, methods, processing systems, and non-transitory computer-readable mediums for generating and using a hierarchical tree structure to enable and capture longer-range correlations (e.g., also referred to as dependencies, interactions, or influences) in a state space model between elements, compared to a flattened sequence of elements. The elements (also referred to as “nodes,” which may be tensors, tuples, or tokens) may be generated from scanning an input object (e.g., a point cloud), in any of various suitable manners, to generate a sequence of elements. In other words, the tree structure may allow for enabling interactions between distant elements, which are elements that would be distant from one another in a flattened sequence of elements. In addition to the tree structure, certain aspects of the present disclosure use a matrix inversion of block-diagonal matrices in a state space model (e.g., a matrix-inversion attention mechanism).

### Example Correlations Between Elements From Scanning an Input Object

In a wide variety of machine learning model architectures, attention (e.g., self-attention) is used to generate model output. For example, many models (such as large language models (LLMs), large vision models (LVMs), and the like) use transformer-based self-attention operations. Generating attention scores during data processing generally includes generating a set of intermediate data (e.g., tensors) for each element of the data (e.g., each token in an input prompt sequence). For example, for each token, the model may compute a key tensor (also referred to in some aspects as the “keys”), a value tensor (also referred to in some aspects as the “values”), and a query tensor (also referred to in some aspects as the “queries”). As used herein, a “token” can generally correspond to any logical element of data. For example, in the case of LLMs, the tokens are generally words, phrases, characters, symbols, or portions thereof. In the case of LVMs, the tokens may correspond to pixels or blocks of pixels (e.g., in an image).

During attention generation, the interactions between each element and every other element are determined. For example, in a sentence “The lake in the middle of the park was very large,” the word “large” directly influences the word “lake” despite the words experiencing large contextual separation. While accounting for influence in this manner can facilitate numerous applications, generating attention is also computationally expensive (e.g., calculating the influence each element has on each other element may be quadratic). Thus, there is a desire for a method of accounting for interactions in a less computationally expensive manner.

State space models attempt to fulfill this desire, but have several drawbacks that make such models undesirable in certain circumstances.

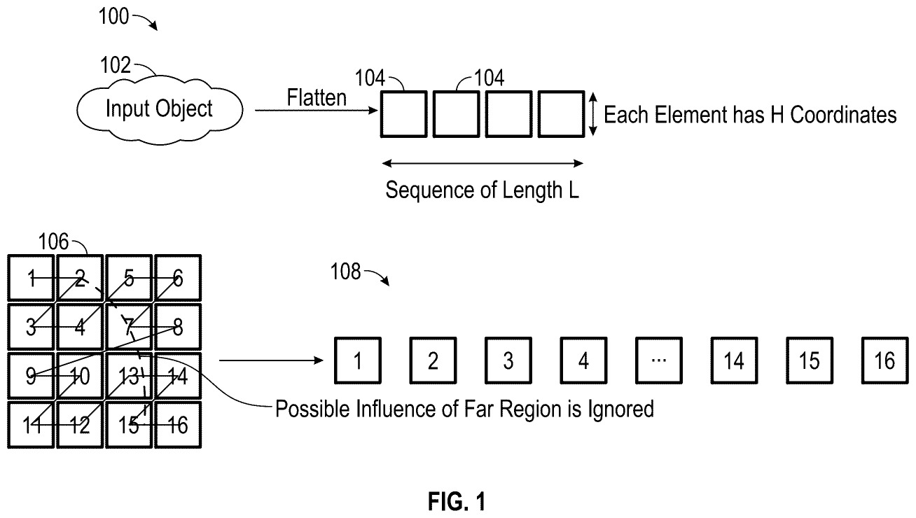

FIG. 1 illustrates an example pipeline 100 for converting an input object 102 into individual elements 104 (e.g., a sequence of elements 108) for processing using a state space model (SSM), according to certain aspects of the present disclosure. The pipeline 100 may be performed by any of various suitable electronic devices and other processing systems, such as a smartphone, a tablet, a personal computer, a server, and the like.

An SSM is a mathematical framework used to describe dynamic systems that evolve over time. SSMs model a system's behavior using a set of latent (hidden) variables, called the state, which encapsulate the internal status of the system at any given time. SSMs operate by analyzing elements in sequential order, applying and accounting for one element's influence on adjacent elements through application of the model.

The example pipeline 100 demonstrates typical implementation of SSMs and their potential limitations. The pipeline 100 includes accessing the input object 102, flattening the input object 102 into the collection of elements 104, and processing the elements 104 sequentially.

The input object 102 may include an input prompt, an image, a video, a point cloud, or any other suitable data format. The input object 102 may be a nested or hierarchical data structure. The input object 102 may be formatted into the individual elements 104, which represent individual portions of data of the input object 102. Herein, the input object 102 and its corresponding elements 104 will be described with reference to tensors (e.g., representing values corresponding to an image or point cloud), but any other data format (e.g., tokens or tuples) may be similarly applied (and may then be embedded into tensors). The input object 102 may be entered by a keyboard or touchscreen or captured by a camera, for example. The input object 102 may be stored within a device performing the SSM.

Flattening the input object 102 includes transforming the data (e.g., the elements 104) of the input object 102 into a single-level, linear structure (e.g., a vector), which may involve removing layers of nesting. In other words, flattening includes rearranging a multi-dimensional set of data elements into a one-dimensional orientation according to a scanning algorithm. Partitioned input object 106 and the sequence of elements 108 demonstrate an example flattening algorithm. The partitioned input object 106 may represent a partitioned version of the input object 102 (e.g., an image divided into pixels).

The partitioned input object 106 includes a four-by-four array of data, identified by elements numbered 1-16. During flattening, a scanning (traversal) algorithm is applied to read each of the elements in order according to a scanning pattern, such as the Z-pattern scanning used in the example of FIG. 1. As is demonstrated by the lines superimposed over the partitioned input object 106, the algorithm begins at element 1, proceeds to 2, then 3, and so on in a Z pattern. This scanning algorithm results in the sequence of elements 108, which may be processed by the SSM.

Notably, while flattening arranges the elements into a format which may be more easily processed by SSMs, flattening does not preserve all interactions (i.e., relationships) between elements. For example, if the partitioned input object 106 is an image, with each element being a pixel, element 2 may not only have a contextual influence on element 1 and/or 3, but may also have a contextual influence on element 15 (as shown by the dotted curve), which is lost due to flattening. By flattening the elements 104 into the sequence of elements 108, much of the context is ignored or reduced in significance.

### Example State Space Model

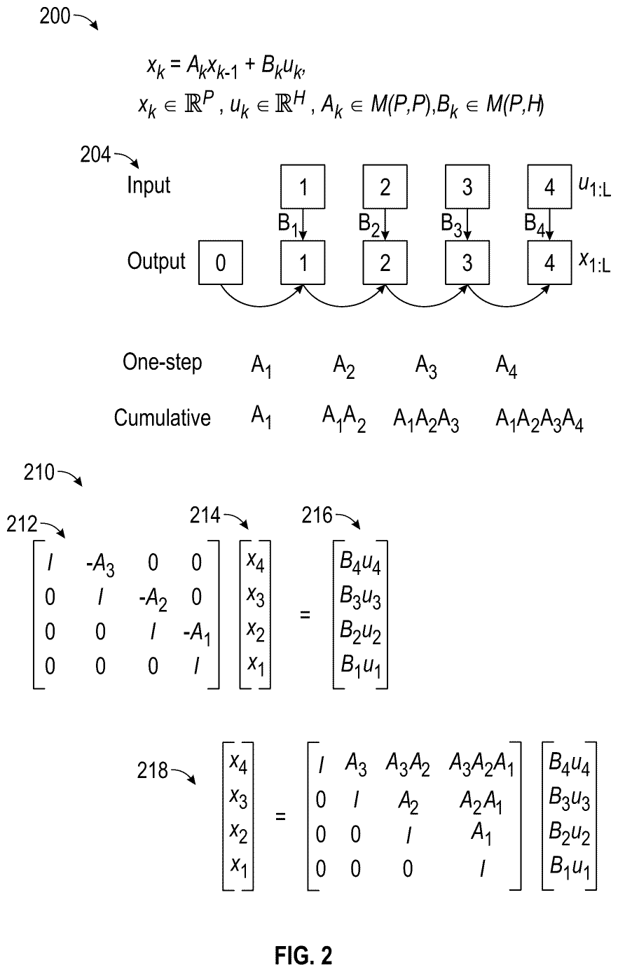

FIG. 2 illustrates an example equation 200, an example process visualization 204, and representative matrices 210 for state space models, according to certain aspects of the present disclosure.

A state space model typically describes a system using two equations: a state transition equation, which defines how the system's internal state evolves, and an output equation, which relates the internal state to the observed output. The state space model for the system may be expressed as equation 200, where x is a state vector at time step k or the previous time step k-1, A is a state transition matrix, B is an input matrix, and u is an input vector.

The process visualization 204 demonstrates how state space models traverse elements one-by-one in a recurrent fashion. As is shown, each previous output is used to supply context for a proceeding output, e.g., output 0 is used to supply context to output 1, which is used to supply context for output 2, etc. In other words, the state space model process is recurrent (e.g., the SSM applies the output of previous elements to process future elements). Cumulatively, the aggregated context from each input may be summarized as the multiplication of each state transition matrix (e.g., the matrix A for each time step).

The aggregated state transition matrices may be used to identify a latent state vector which represents each analyzed element. Such an identification is illustrated by matrices 210.

The aggregation of state transition matrices may be represented in a matrix 212, where A₁ is a first state transition matrix, A₂ is a second state transition matrix, and A₃ is a third state transition matrix, each state transition matrix being accumulated during the SSM process. By arranging the state transition matrices into the matrix 212, multiplying the matrix 212 by a matrix 214 (containing latent state vectors), and setting the product equal to a matrix 216 (which includes the input matrices multiplied by corresponding input vectors), matrix multiplication may be applied to determine the latent state vectors. The result of the matrix multiplication is shown in matrix 218.

### Example Hierarchical Tree Structure and Matrix Inversion

The accumulated interactions of multiple elements (e.g., elements 104) may be represented by a tree-structured layer or matrix, as described herein.

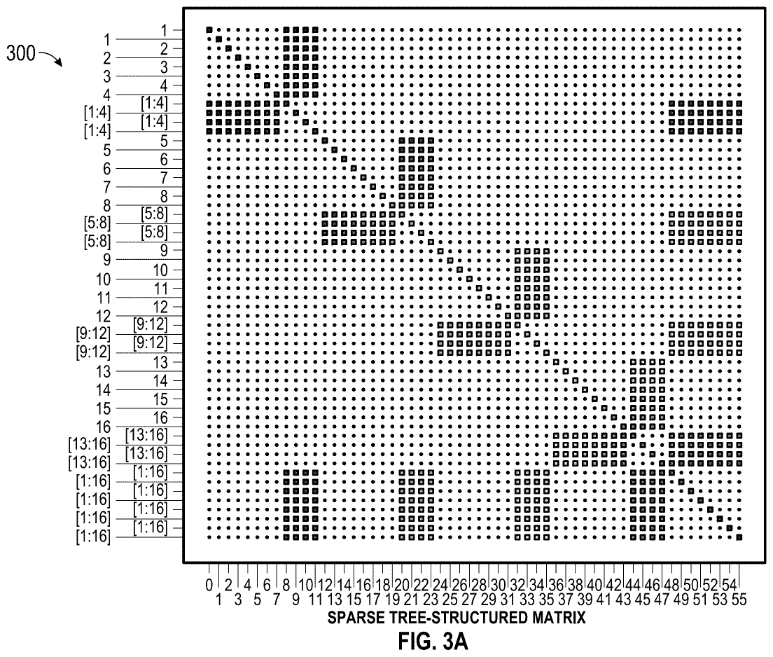

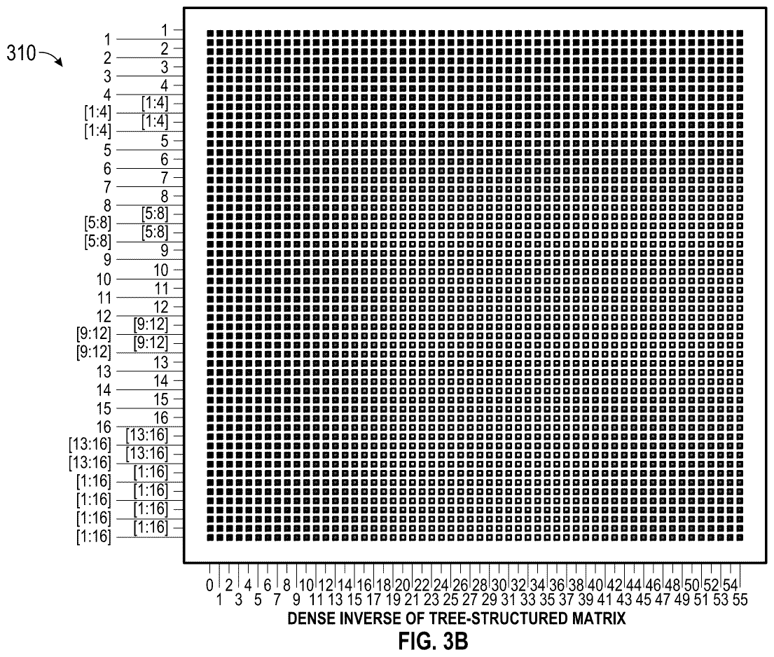

FIG. 3A illustrates an example sparse tree-structured matrix 300 (e.g., matrix T), according to certain aspects of the present disclosure. FIG. 3B illustrates an example dense inverse matrix 310 (e.g., matrix T⁻¹), which is the inverse of the tree-structured matrix 300. By applying a dense matrix, but in an efficient way (namely, as the inversion of a sparse matrix), the influence of an element (e.g., a tensor, tuple, or token) on all other elements may be taken into account (and thus effectively applied in the state space model).

The tree-structured matrix 300 (for a given layer of a machine learning model) may characterize the state variables x and the input variables u via the equation Tx=u, where u is the input to the given layer. The layer can be considered as implementing this block-tree-structured (hence sparse) matrix equation. This may allow for more efficient inversion to solve for the state variables x (according to x=T⁻¹u) to generate the state space model, without explicit materialization of the matrix 300 or its blocks in some aspects.

Certain aspects of the present disclosure include assignment of subsets of nodes (e.g., tuples or tokens) to one or more first meta-nodes and assignment of subsets of first meta-nodes to one or more second meta-nodes to generate a tree structure. Meta-nodes may also be referred to herein as “virtual nodes.” The tree structure is a hierarchy and is used to introduce interactions among all the elements (e.g., via virtual nodes or via elements organized into higher levels of the tree structure), significantly better than an input that is simply flattened into a one-dimensional sequence, as in FIG. 1.

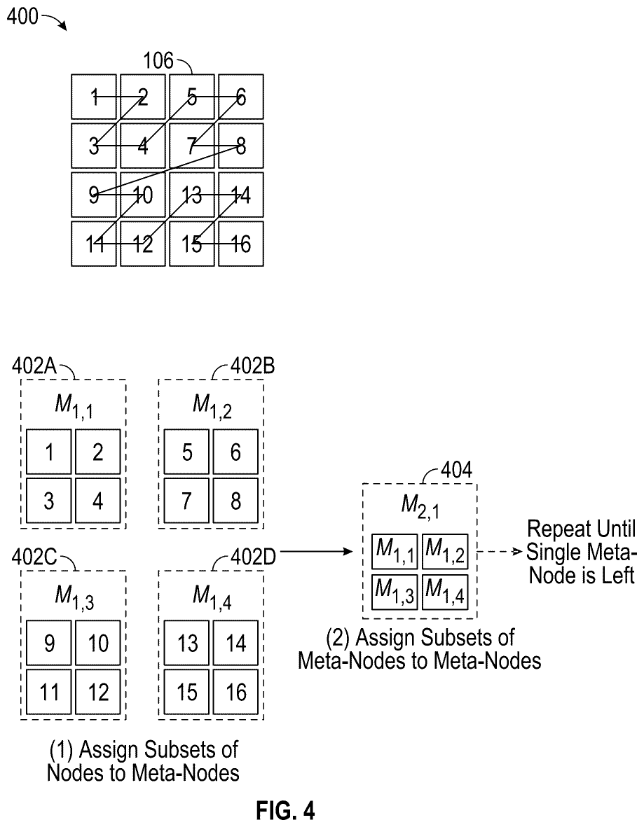

FIG. 4 illustrates an example pipeline 400 for generating a tree structure, according to certain aspects of the present disclosure. The generation of the tree structure may occur before the machine learning model utilizing the tree structure is trained.

The pipeline 400 may involve: (1) assigning subsets of nodes (e.g., elements 104) of an input object 106 to meta-nodes 402 (e.g., meta-nodes M_{1,1}, M_{1,2}, M_{1,3}, and M_{1,4} at a first meta-node level) of the tree structure and (2) assigning subsets of meta-nodes to higher-level meta-nodes 404 (e.g., meta-node M_{2,1} at a second meta-node level). In this manner of generating a tree structure having multiple levels, the tree structure is a hierarchical tree structure.

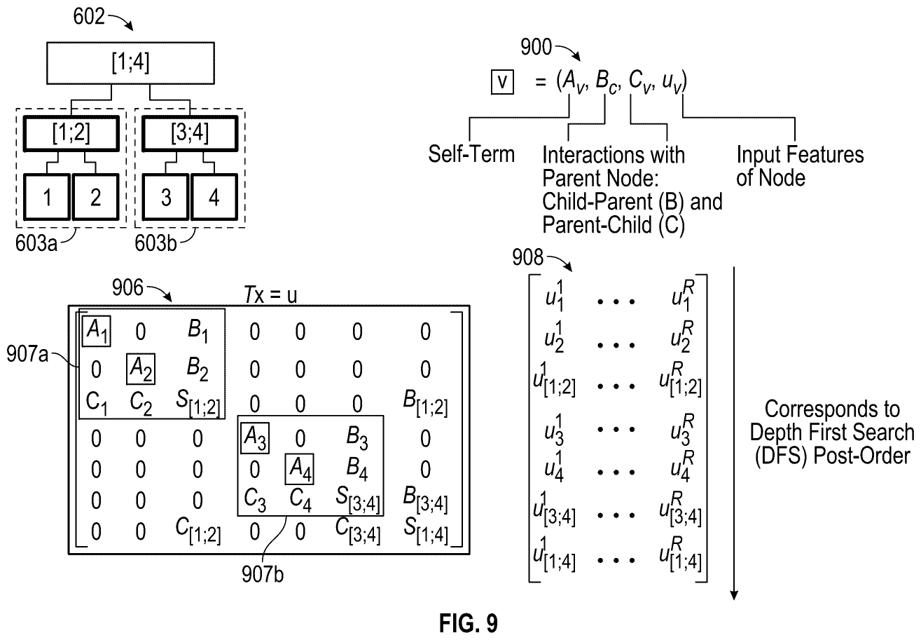

That is, the tree structure may be the result of grouping nodes and meta-nodes for subsequent processing to enable interactions between distant nodes. Grouping the nodes may include generating a set of meta-nodes and assigning one or more nodes to each meta-node. In other words, the nodes are treated as leaves (also referred to herein as “leaf nodes”) of the tree structure, and each of the meta-nodes is considered as a branch or a root (also referred to herein as a “branch node” or a “root node”) of the tree structure. The nodes and meta-nodes of the tree structure may each be considered as a vertex, which is associated with a set of terms, described in more detail with reference to FIG. 9. These terms may indicate the interactions between the nodes and meta-nodes. In this manner, the root node of the tree structure may indicate the accumulation of all the interactions between the nodes and meta-nodes (e.g., in a sparse tree-structured matrix T, at least conceptually).

In the pipeline 400, a given expected input object may be organized into a tree structure to enable interactions between distant nodes. For example, the input object 106 may be considered as the expected input object and organized into a tree structure. The input object 106 includes sixteen nodes (e.g., elements 104). Building the tree structure can include grouping the sixteen nodes to be associated with four higher-level groups (e.g., four meta-nodes), each meta-node containing four nodes. Meta-nodes 402A (labeled “M_{1,1}” for meta-node level 1 and index 1), 402B (labeled “M_{1,2}” for meta-node level 1 and index 2), 402C (labeled “M_{1,3}” for meta-node level 1 and index 3), and 402D (labeled “M_{1,1}” for meta-node level 1 and index 4) are an example of such meta-nodes (collectively referred to herein as “meta-nodes 402”). Meta-nodes 402 can also be grouped to be associated with meta-node 404 (labeled “M_{2,1}” for meta-node level 2 and index 1, where meta-node level 2 is higher than meta-node level 1). This grouping of meta-nodes to be associated with higher-level meta-nodes continues until a single meta-node (the root node) is left.

The meta-node above a node may be referred to as a parent node, and a node below a parent node may be referred to as a child node. Thus, in a tree structure with more than two levels, a meta-node can be both a parent node and a child node. For example, a meta-node may have two child nodes and be associated with another, higher-level meta-node (the lower-level meta-node's parent node).

The nodes assigned to each meta-node 402 may be selected with any suitable method. For example, as shown in the example of FIG. 4, meta-node 402A can be associated with the first four nodes (1-4) according to the scanning pattern (e.g., z-sweeping), meta-node 402B can be associated with nodes five through eight (5-8), meta-node 402C can be associated with nodes nine through twelve (9-12), and meta-node 402D can be associated with nodes thirteen through sixteen (13-16). In other aspects, the nodes assigned to each meta-node 402 may be selected via random selection, numerical selection based upon being an odd-or even-numbered node, or any other suitable method.

Although only two meta-node levels are shown in FIG. 4, it is to be understood that a tree structure may include more or fewer than two meta-node levels. Also, although each meta-node 402 includes the same number of nodes and is the same shape (e.g., a 4×4 array), it is to be understood that different meta-nodes (including meta-nodes in the same level) may include different numbers of nodes and/or may have different shapes. In addition, the meta-nodes in one level need not include the same number of meta-nodes or nodes as meta-nodes in another level. Furthermore, it is to be understood that a meta-node need not have a square shape and that a meta-node may use a shape with different numbers of row(s) and column(s).

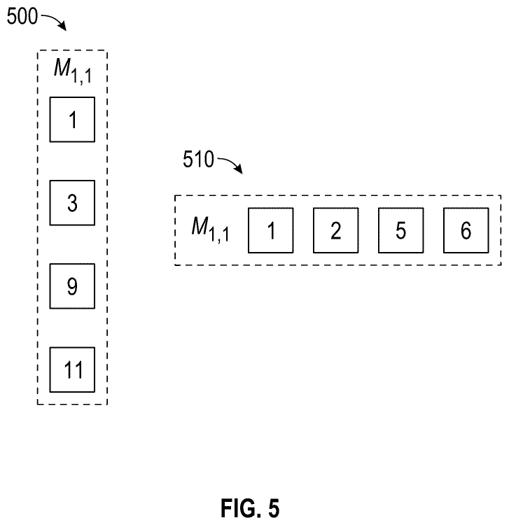

FIG. 5 illustrates different alternative shapes for the meta-nodes, according to certain aspects of the present disclosure. For example, rather than an array (e.g., a square, as shown in the meta-nodes 402 and 404 of FIG. 4), a column shape 500 may be used for grouping the nodes from the input object 106 (or grouping the lower-level meta-nodes) to be associated with a meta-node to form a tree structure. As another example, a row shape 510 may be used for grouping the nodes from the input object 106 (or grouping the lower-level meta-nodes) to be associated with a meta-node.

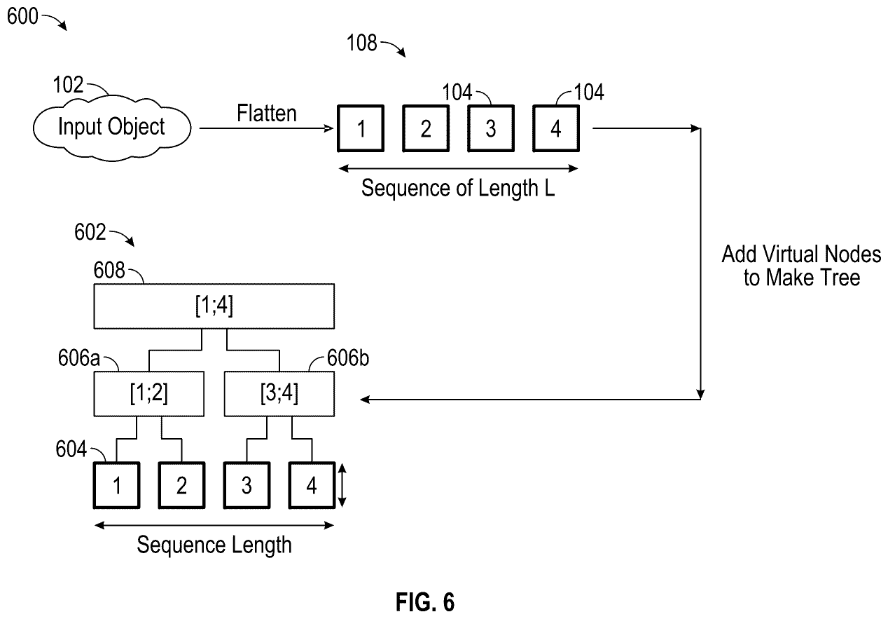

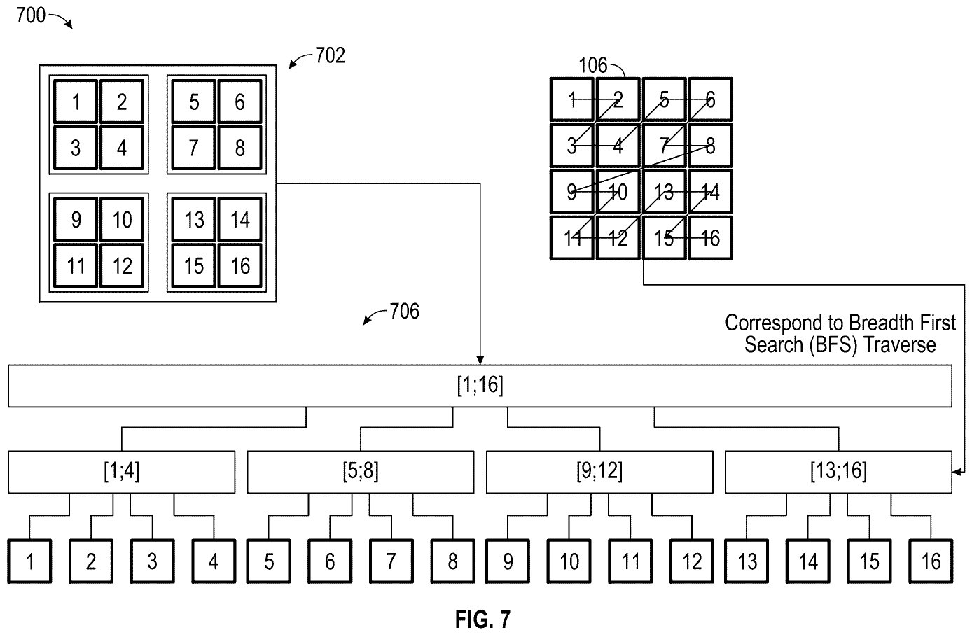

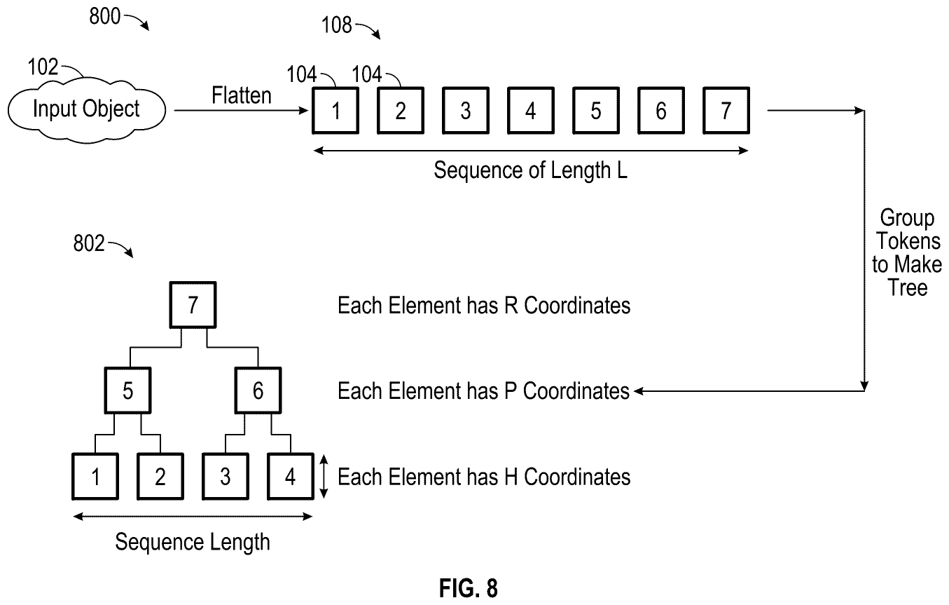

From a sequence of nodes (e.g., tensors, tuples, or tokens), the tree structure may be constructed using one or more levels of virtual nodes (as illustrated in FIGS. 6 and 7) or by organizing (existing) nodes from the sequence into a hierarchy with multiple levels (as depicted in FIG. 8).

FIG. 6 illustrates an example pipeline 600 for generating a tree structure 602 using virtual nodes, according to certain aspects of the present disclosure.

In some aspects, when generating a tree structure, an input object 102 may be accessed and flattened into a sequence of elements 108. As is shown, the input object 102 is flattened into four elements 104 (nodes 1, 2, 3, and 4). The sequence of elements 108 may be arranged into the tree structure 602 via the methods described herein. In some aspects, as illustrated in FIG. 6, the four elements 104 of the sequence of elements 108 may be organized into the bottommost layer of the tree structure 602 as leaf nodes 604.

Nodes 1 and 2 may be assigned to a virtual node [1; 2] (also referred to as a branch node 606a), and nodes 3 and 4 may be assigned to a virtual node [3; 4] (also referred to as a branch node 606b). The virtual nodes [1; 2] and [3; 4] may be assigned to a virtual node [1; 4] (also referred to as a root node 608 of the tree structure 602). In this manner, the influences of nodes 1 and 2 may be captured by virtual node [1; 2], and the influences of nodes 3 and 4 may be captured by virtual node [3; 4]. Thus, virtual node [1; 4] may capture the interactions among nodes 1, 2, 3, and 4, via the virtual nodes [1; 2] and [3; 4].

Each of the leaf nodes 604 (e.g., elements 104) may have H number of coordinates, each branch node 606 may have P number of coordinates, and the root node 608 may have R number of coordinates.

FIG. 7 illustrates an example pipeline 700 for generating a hierarchical tree structure 706 using quadtrees with virtual nodes, according to certain aspects of the present disclosure. The tree structure 706 may be constructed from an input object 702, in which 4×4 arrays of elements are scanned according to a z-sweeping algorithm (as shown in the corresponding input object 106) to generate a flattened sequence of nodes 1 to 16. The sequence of nodes 1 to 16 may be used as the leaf nodes of the tree structure 706, corresponding to a breadth-first search (BFS) that traverses the entire first level of the hierarchical tree structure 706 at the start of a forward pass.

Nodes 1 to 4 may be assigned to a virtual node [1; 4], nodes 5 to 8 may be assigned to a virtual node [5; 8], nodes 9 to 12 may be assigned to a virtual node [9; 12] and nodes 13 to 16 may be assigned to a virtual node [13; 16]. With each virtual node at the first meta-node level of the tree structure 706 being associated with four nodes, this type of tree structure may be referred to as a “quadtree.” The virtual nodes [1; 4], [5; 8], [9; 12], and [13; 16] may be assigned to a virtual node [1; 16] (also referred to as a root node of the tree structure 706) at the second meta-node level. In this manner, the influences of nodes 1 to 4 may be captured by virtual node [1; 4], the influences of nodes 5 to 8 may be captured by virtual node [5; 8], the influences of nodes 9 to 12 may be captured by virtual node [9; 12], and the influences of nodes 13 to 16 may be captured by virtual node [13; 16]. Thus, virtual node [1; 16] may enable interactions among nodes 1 to 16, via the virtual nodes [1; 4], [5; 8], [9; 12], and [13; 16], including interactions between distant nodes in the flattened sequence.

FIG. 8 illustrates an example pipeline 800 for generating a tree structure 802 by grouping and effectively arranging elements 104 into multiple levels of a hierarchy, according to certain aspects of the present disclosure.

Generating the tree structure 802 may include organizing a set of elements 104 (e.g., nodes) from an input object 102 into the hierarchical tree structure without meta-nodes. For example, some elements may be included in the bottommost level of the tree structure 802, whereas other elements may be conceptually included at higher levels of the tree structure. In the example of FIG. 8, nodes 1 to 4 are organized into leaf nodes at the bottom of the tree structure 802. Nodes 1 and 2 may be assigned to node 5, and nodes 3 and 4 may be assigned to node 6, as shown. Nodes 5 and 6 may be assigned to node 7 (also referred to as a root node of the tree structure 802). In this manner, the influences of nodes 1 and 2 may be captured by node 5, and the influences of nodes 3 and 4 may be captured by node 6. Thus, node 7 may capture the interactions between nodes 1, 2, 3, and 4, via nodes 5 and 6, thereby enabling interactions between distant nodes in the flattened sequence. In certain aspects, the hierarchical tree structure may be constructed using any suitable algorithm or method, including but not limited to breadth-first search, depth-first search, random assignment, learned/adaptive grouping, or domain-specific strategies.

FIG. 9 illustrates an example tree matrix T with various terms representing different interactions between nodes of the tree structure 602, according to certain aspects of the present disclosure.

During traversal of the tree structure 602, interactions between nodes may be accumulated along with input features at each level of the tree structure 602. Each node (e.g., tensor, tuple, or token) may be represented by a vertex v with a vertex characterization 900, in which v =(Aᵥ, B_{c}, Cᵥ, uᵥ). In the vertex characterization 900, Aᵥ is a self-term (where Sᵥ is a self-term for virtual nodes), B_{c} represents the interaction from child to parent nodes (how a child node interacts with its parent node), Cᵥ represents the interaction from parent to child nodes (how a parent node interacts with its child nodes), and uᵥ represents the input features of the node. A root node has no parent node, and a leaf node has no child nodes. A branch node may be considered as the parent node of a leaf node (or another branch node), but as the child node of the root node (or of another branch node).

To capture the interactions between nodes, the tree structure may be traversed from leaves to root and from root to leaves (conceptually similar to U-Net encoding and decoding). When traversal reaches the root node (e.g., meta-node [1; 4]) of the tree structure 602, the accumulated interactions may be (at least conceptually) formed into the tree matrix T 906. The tree matrix T 906 includes accumulated interactions for subtree structure 603a (with nodes 1 and 2 and virtual node [1; 2]) in submatrix 907a (with terms A₁, A₂, B₁, B₂, C₁, C₂, and S_{[1;2]}) and accumulated interactions for the subtree 603b (with nodes 3 and 4 and virtual node [3; 4]) in submatrix 907b (with terms A₃, A₄, B₃, B₄, C₃, C₄, and S_{[3;4]}). The accumulated input features may be (at least conceptually) formed into matrix 908 with an input feature row for each node and for each virtual node in the tree structure, having a column dimension R.

The inverse of the sparse tree matrix T may be applied during step two of the forward pass to determine state variables of the nodes. Alternatively, one could solve directly for the state variables x by calculating x=T⁻¹u.

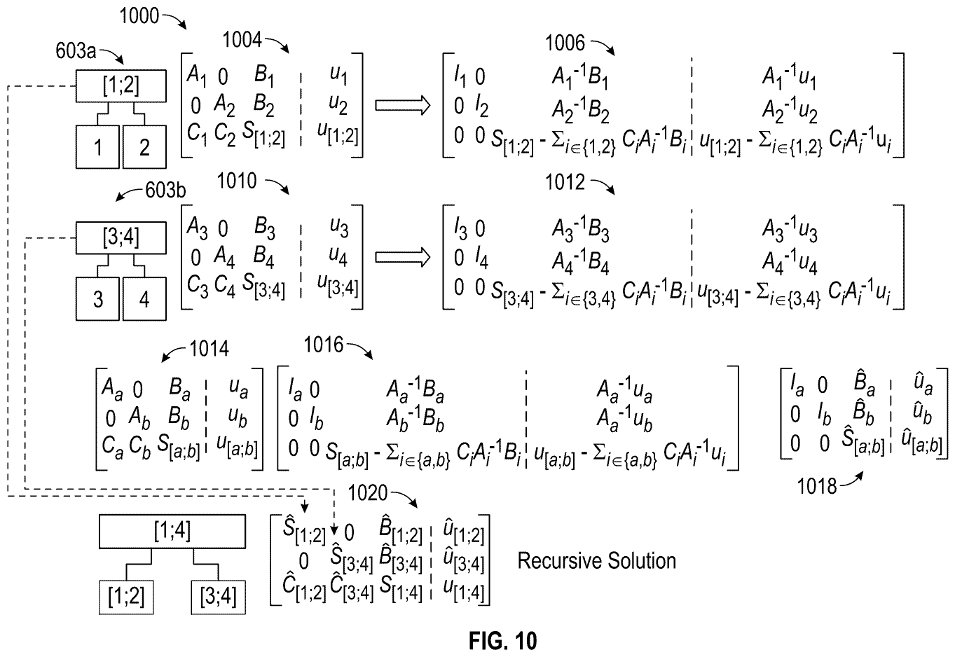

FIG. 10 illustrates example matrices 1000 for a forward pass through the tree structure, according to certain aspects of the present disclosure. The forward pass represents inferencing using the tree structure. The example matrices 1000 illustrate accumulation of interactions, self-terms, and input features to generate matrices for each vertex (e.g., each node and meta-node) with the ultimate accumulation of a tree matrix T at the root node of the tree structure. The example matrices 1000 also illustrate the inverse of the matrices for each vertex.

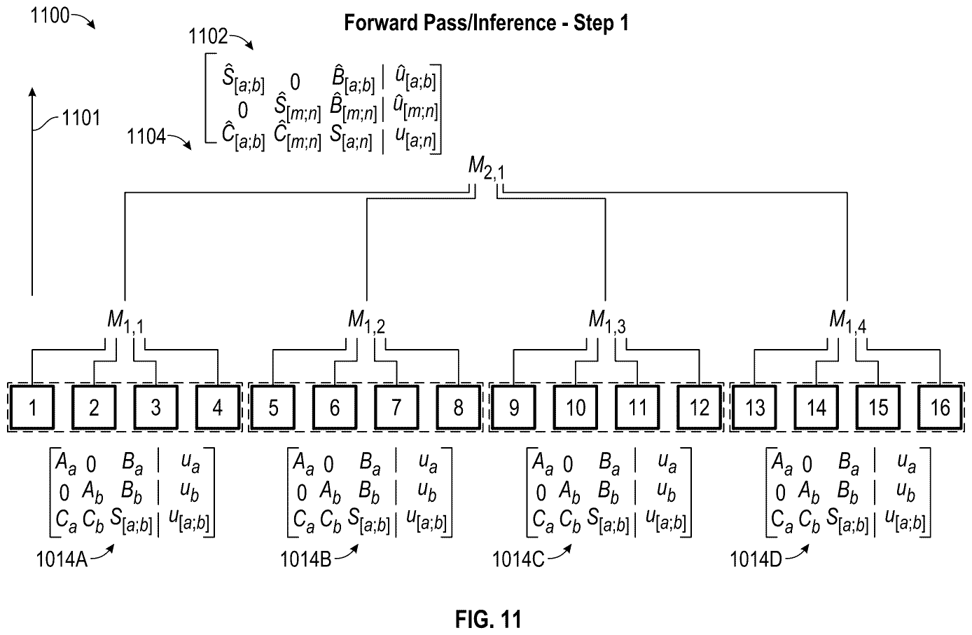

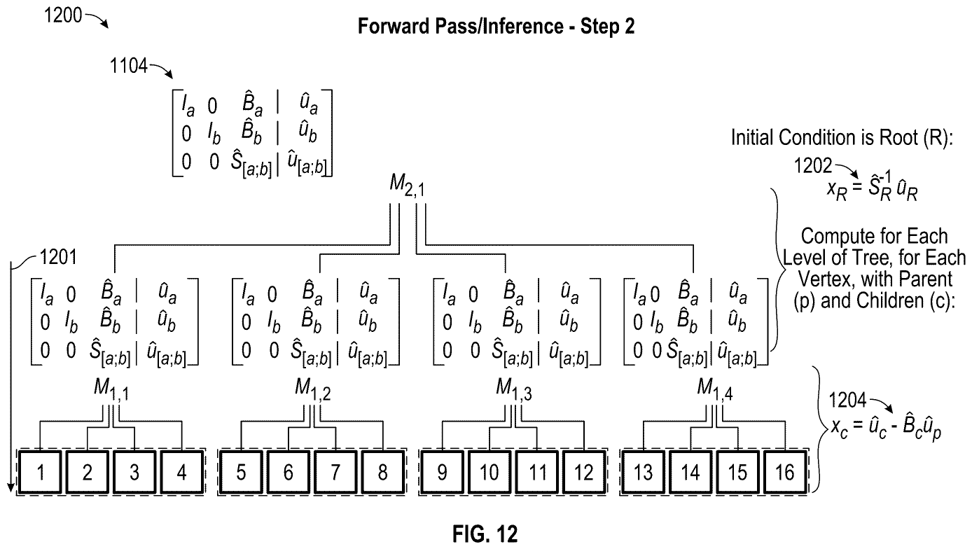

The nodes and meta-nodes included in subtree structures 603a and 603b correspond to matrices 1004 and 1010, respectively (similar to subtree structure 603a and 603b corresponding to submatrices 907a and 907b in FIG. 9). During the accumulation of nodes 1 to 4 (step one of the forward pass as illustrated in FIG. 11), the matrices 1004 and 1010 may be (at least conceptually) generated. During step two of the forward pass (as illustrated in FIG. 12), matrices 1006 and 1012—which are inverses of matrices 1004 and 1010, respectively—may be (at least conceptually) generated and used to determine state variables x for each meta-node and node of the tree structure (e.g., tree structure 602, with meta-nodes and nodes of the subtree structures 603a and 603b).

Matrix 1014 is a generalized format of matrices 1004 and 1010, and matrix 1016 is a generalized format of matrices 1006 and 1012 and represents an inverse form of matrix 1014. During traversal of the tree structure, the nodes are supplied inputs from the applicable nodes and meta-nodes, and the terms Aₐ, A_{b}, Bₐ, B_{b}, Cₐ, C_{b}, uₐ, u_{b}, u_{[a;b]}, and S_{[a;b]}are populated accordingly. Matrix 1020 may represent the ultimate accumulation of a tree matrix T at the root node of the tree structure (e.g., the recursive solution).

After the tree matrix T is constructed (or at least all of the interactions have been accumulated), step two of the forward pass may proceed by application of matrices (similar to matrix 1016) at each respective meta-node and node, facilitating determination of state variables x for each meta-node and node. Matrix 1016 can be rewritten as simplified matrix 1018 by defining new variables (e.g., \hat{B}ₐ, \hat{B}_{b}, ûₐ, û_{b}, û_{[a;b]}, and Ŝ_{[a;b]}), such that matrix 1018 may be effectively applied during the determination of state variables.

FIG. 11 illustrates an example forward pass 1100 through a tree structure 1104 from leaf nodes to the root node with the example matrices 1000 of FIG. 10, according to certain aspects of the present disclosure. In a first step of an overall forward pass, given the tree structure 1104, information of the leaf nodes (e.g., terms Aᵥ, B_{c}, Cᵥ, and uᵥ) may be propagated through the subtrees, each subtree consisting of a parent node and one or more child nodes, towards the root node of the tree structure (e.g., leaves to root), as indicated by arrow 1101. The tree structure 1104 may be a trained tree structure, in which each vertex (including the meta-nodes) has populated parameters (e.g., terms Sᵥ, B_{c}, Cᵥ, and uᵥ).

When the nodes and meta-nodes are analyzed to accumulate interactions and input features, matrices 1014A-D (generally referred to herein as the “matrix 1014”) may conceptually represent the information at each node and meta-node, although only two child (meta-)nodes and one parent meta-node are reflected in the matrix 1014. The real matrix for the vertices in the tree structure 1104 will be larger, representing four child (meta-)nodes and one parent meta-node. Matrices with different shapes may be used, depending on the tree structure. Upon accumulation through the entire tree structure 1104, the root node (M_{2,1}) may have a tree matrix 1102 constructed. Tree matrix 1102 may conceptually represent accumulated interactions from the nodes and meta-nodes, although the real matrix for the root node of tree structure 1104 will be larger with more terms. The tree matrix 1102 will represent the interactions of all nodes (e.g., nodes 1 to 16) and may be similar to matrix 1020 in FIG. 10, although the real matrix for the root node in the tree structure 1104 will be larger.

FIG. 12 illustrates an example forward pass 1200 through the tree structure 1104 from the root node to the leaf nodes (as indicated by arrow 1201) with the example matrices of FIG. 10, according to certain aspects of the present disclosure. This forward pass 1200 may represent step two of the overall forward pass. Starting from the root node, the state variables x may be solved by traversing the tree structure 1104 via lower subtrees (e.g., root to leaves). Now the earlier nodes in the previous traversal become the later nodes in this traversal.

Solving for the state variables x may include effectively using an inverse matrix at each vertex (similar to matrix 1018) and applying equation 1202 or 1204 as appropriate, where x_{R} represents the state variables of the root node and xc represents the state variables of the child nodes.

Once the state variables x for each node are computed, the state variables may be processed. In some aspects, processing the state variables includes determining a next state. For example, processing the state variables can include predicting a token in response to an input prompt or classifying an object in an image.

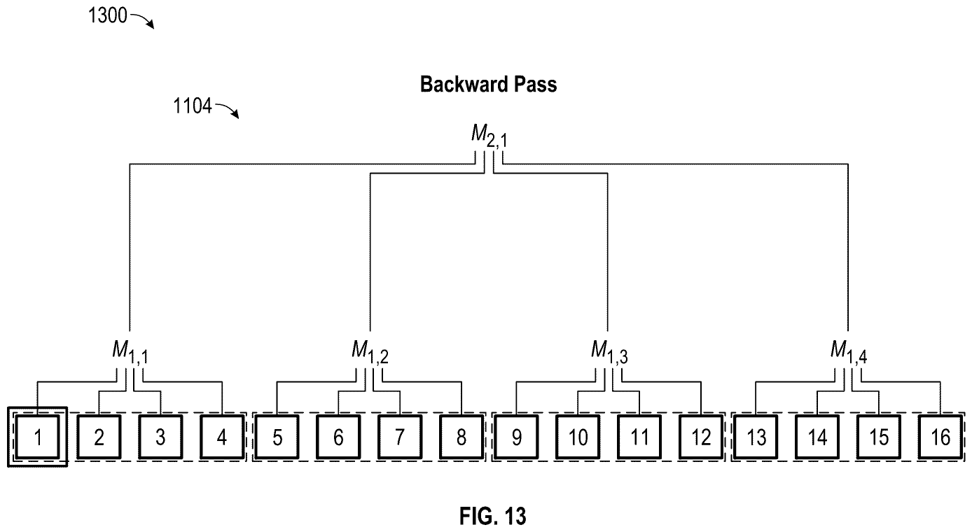

FIG. 13 illustrates an example backward pass 1300 through the tree structure 1104, according to certain aspects of the present disclosure. The backward pass 1300 is generally the same as the forward pass, but may be applied to train (e.g., adjust) the parameters (e.g., the terms Aᵥ, B_{c}, Cᵥ, uᵥ, and Sᵥ) of each vertex (e.g., each node and meta-node) before deployment of the tree structure (e.g., in a machine learning model). To perform the backward pass 1300, in addition to the steps described above for the forward pass, a derivative between each vertex and its parent node is generated. This derivative may be used to adjust the parameters of each vertex in the tree structure until the state variables x match the expected state variables for a ground-truth input object, similar to backpropagation in training other types of machine learning models.

In certain aspects, the hierarchical tree structure and associated state space model described herein may be utilized in combination with other neural network architectures, such as transformer neural networks, convolutional neural networks (CNNs), or other machine learning models. For example, the tree-structured state space model may be implemented as one or more layers within a larger model that also includes transformer or CNN layers, or may be used in sequence, parallel, or interleaved with such layers. This hybrid approach enables leveraging the complementary strengths of different architectures, such as efficient long-range dependency modeling by the tree-structured state space model and powerful local feature extraction or attention mechanisms by transformer or CNN layers. The outputs of the tree-structured state space model may be provided as inputs to other neural network layers, or vice versa, and the overall model may be trained end-to-end using standard machine learning techniques.

### Example Operations for Machine Learning

A tree structure as described herein may capture more complex inter-dependencies in the data compared to a flattened sequence. According to certain aspects of the present disclosure, a hierarchical tree structure with virtual nodes (or grouped nodes from the flattened sequence effectively arranged into different levels) may be created to capture interactions among distant nodes. Next, interactions among nodes and meta-nodes may be determined, and a matrix T for a state space model may be generated. Then, an action (e.g., output a classification of an image) may be taken based on the state space model solution.

In some aspects, input may be propagated from leaves to the root of a tree structure, the tree structure having at least two hierarchical levels. State variables for lower subtrees (lower levels) may be solved, traversing from root to leaves. Then, an action may be taken (e.g., a classification of an image may be output) based on the state space model solution. The tree structure may capture longer-range correlations among input elements. Each subtree may include a parent node and one or more child nodes. In some aspects, the parent nodes may be virtual nodes. Each node may be associated with a self-term (Aᵥ or Sᵥ), a first interaction term (B_{c}) indicating how a child node interacts with a parent node, a second interaction term (Cᵥ) indicating how a parent node interacts with a child node, and input features of the node (uᵥ).

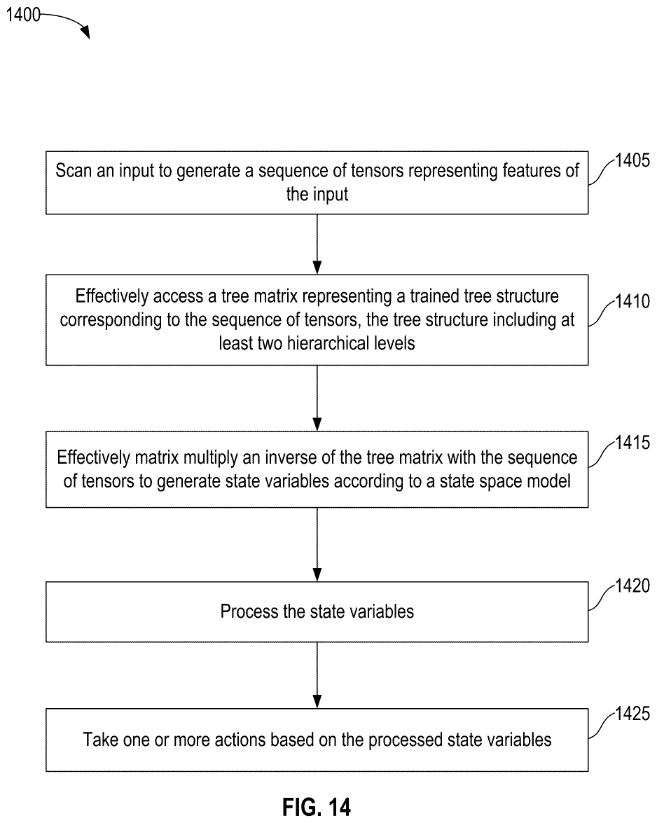

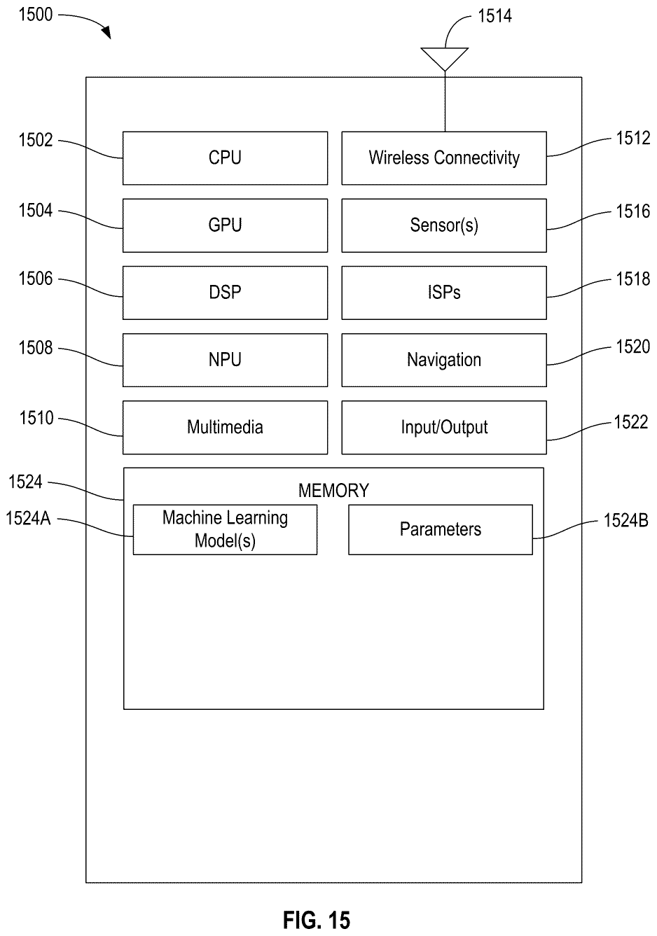

FIG. 14 illustrates example operations 1400 for machine learning, according to certain aspects of the present disclosure. The operations 1400 may be performed, for example, by a computing system on which one or more machine learning models may be trained, such as a server computer, a cluster of physical or cloud computing instances, or other computing systems (e.g., such as the processing system 1500 illustrated in FIG. 15 and described in further detail below).

As illustrated, the operations 1400 begin at block 1405, with the computing system scanning an input to generate a sequence of tensors representing features of the input (e.g., vertex characterization term uᵥ). The input may include the input objects 102 or 106. In some aspects, the scanned input may yield a sequence of elements (e.g., sequence of elements 108) with features of the input, which may be embedded into the sequence of tensors representing these input features.

At block 1410, the computing system may access a tree matrix (e.g., matrix T representing a trained tree structure (e.g., tree structure 602 or 802) corresponding to the sequence of tensors. The tree structure includes at least two hierarchical levels.

At block 1415, the computing system may effectively matrix multiply an inverse of the tree matrix (e.g., inverse matrix T⁻¹) with the sequence of tensors to generate state variables (e.g., state variables x) according to a state space model (SSM). As used in this context, “effectively” may involve actual matrix multiplication or performance of another set of one or more operations having the same effect as matrix multiplication with the inverse of the tree matrix.

The computing system may process the state variables at block 1420. In some aspects, the state variables may be processed with a trained machine learning model.

At block 1425, the computing system may take one or more actions based on the processed state variables.

According to some aspects, the tree structure comprises a root node (e.g., meta-node M_{2,1}) and one or more subtree structures (e.g., subtree structures 603a, 603b) branching from the root node to a plurality of leaf nodes (e.g., elements 104). The leaf nodes may represent at least some of the sequence of tensors. In such cases, each subtree structure may include a parent node at a higher level of the tree structure and one or more child nodes at a lower level of the tree structure. The sequence of tensors may be the child nodes at a bottommost level of the tree structure. In some aspects, the parent node is a virtual node (e.g., as described with respect to FIGS. 6 and 7), whereas in other aspects, the parent node is a tensor in the sequence of tensors (e.g., as described with respect to FIG. 8). In some aspects, each node in the tree structure is associated with a self-term (e.g., Aᵥ or Sᵥ), a first interaction term (e.g., B_{c}) indicating a child-to-parent relationship for the node, a second interaction term (e.g., Cᵥ) indicating a parent-to-child relationship for the node, and input features (e.g., uᵥ) of the node. In such cases, the self-term, the first interaction term, and the second interaction term may be included in the tree matrix for each node.

In some aspects, effectively accessing the tree matrix at block 1410 involves propagating first information associated with each leaf node of the tree structure towards the root node of the rooted tree structure. In such aspects, effectively matrix multiplying the inverse of the tree matrix with the sequence of tensors at block 1415 may include solving for the state variables by propagating second information associated with the root node towards the plurality of leaf nodes of the tree structure. Thus, in some aspects, accessing the tree matrix at block 1410 corresponds to step one of the forward pass, as described above with reference to FIG. 11, and the effectively matrix multiplying at block 1415 may correspond to step two of the forward pass, as described above with reference to FIG. 12.

In some aspects, the tree structure captures correlations among non-adjacent tensors in the sequence (or between non-adjacent elements in the sequence of elements or between non-adjacent elements in the input).

In some aspects, the tree structure is capable of capturing a correlation between an initial tensor in the sequence and a last tensor in the sequence (or between an initial element in the sequence of elements and a last element in the sequence of elements).

According to some aspects, the input is a point cloud or an image. In such cases, taking one or more actions at block 1425 may include detecting one or more objects in the point cloud or the image, classifying one or more objects in the point cloud or the image, performing facial recognition on the image, etc.

In some aspects, processing the state variables at block 1420 may include generating a next state based upon the state variables. For example, the input may be an input prompt, and in this case, processing the state variables may include generating a text response to the input prompt.

In some aspects, taking one or more actions at block 1425 may include generating and/or providing an output based upon the content of the processed state variables.

In certain aspects, the hierarchical tree structure may be utilized in a coarse-grain pipeline, wherein computations are performed not only at the leaf nodes, but also at higher, non-leaf levels of the tree. By aggregating and processing groups of elements at intermediate meta-node levels, the model can reduce computational and memory demands while still capturing long-range dependencies. This coarse-grain approach enables efficient modeling of large or complex inputs, such as high-resolution images or extensive point clouds, by operating on subsets of the data at varying levels of granularity. The coarse-grain pipeline may be implemented by selectively applying the recursive scan and matrix inversion operations at chosen levels of the tree hierarchy, thereby balancing modeling accuracy and resource efficiency.

### Example Processing System for Inferencing Based on a Hierarchical Tree Structure

FIG. 15 depicts an example processing system 1500 configured to perform various aspects of the present disclosure, including, for example, the techniques and apparatus described with respect to FIGS. 1-14. In some aspects, the processing system 1500 may execute inferencing operations using a trained machine learning model. Although depicted as a single system for conceptual clarity, in at least some aspects, as discussed above, the operations described below with respect to the processing system 1500 may be distributed across any number of devices.

The processing system 1500 includes a central processing unit (CPU) 1502, which in some examples may be a multi-core CPU. Instructions executed at the CPU 1502 may be loaded, for example, from a program memory associated with the CPU 1502 or may be loaded from a partition of memory 1524.

The processing system 1500 also includes additional processing components tailored to specific functions, such as a graphics processing unit (GPU) 1504, a digital signal processor (DSP) 1506, a neural processing unit (NPU) 1508, a multimedia processing unit 1510, and a wireless connectivity component 1512.

An NPU, such as NPU 1508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1508, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance therebetween. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 1508 is a part of one or more of the CPU 1502, the GPU 1504, and/or the DSP 1506.

In some examples, the wireless connectivity component 1512 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 1512 is further coupled to one or more antennas 1514.

The processing system 1500 may also include one or more sensor processing units 1516 associated with any manner of sensor, one or more image signal processors (ISPs) 1518 associated with any manner of image sensor, and/or a navigation component 1520, which may include satellite-based positioning system components (e.g., GPS or GLONASS) as well as inertial positioning system components.

The processing system 1500 may also include one or more input and/or output devices 1522, such as screens, touch-sensitive surfaces (including touch-sensitive displays), physical buttons, speakers, microphones, and the like.

In some examples, one or more of the processors of the processing system 1500 may be based on an ARM or RISC-V instruction set.

The processing system 1500 also includes the memory 1524, which is representative of one or more static and/or dynamic memories, such as a dynamic random access memory, a flash-based static memory, and the like. In this example, the memory 1524 includes computer-executable components, which may be executed by one or more of the aforementioned processors of the processing system 1500.

In particular, in this example, the memory 1524 includes machine learning models 1524A (which, as discussed above, may include a transformer neural network and one or more state space models) and parameters 1524B for the machine learning models 1524A. Though depicted as discrete components for conceptual clarity in FIG. 15, the illustrated components (and others not depicted) may be collectively or individually implemented in various aspects.

Generally, the processing system 1500 and/or components thereof may be configured to perform the methods described herein.

Notably, in other aspects, aspects of the processing system 1500 may be omitted, such as where the processing system 1500 is a server computer or the like. For example, the multimedia processing unit 1510, the wireless connectivity component 1512, the sensor processing units 1516, the ISPs 1518, and/or the navigation component 1520 may be omitted in other aspects. Further, aspects of the processing system 1500 may be distributed between multiple devices.

### Example Clauses

Implementation details of various aspects of the present disclosure are described in the following numbered clauses:
Clause 1: A processor-implemented method for machine learning, comprising: scanning an input to generate a sequence of tensors representing features of the input; effectively accessing a tree matrix representing a trained tree structure corresponding to the sequence of tensors, the tree structure including at least two hierarchical levels; effectively matrix multiplying an inverse of the tree matrix with the sequence of tensors to generate state variables according to a state space model; processing the state variables; and taking one or more actions based on the processed state variables.
Clause 2: The processor-implemented method of Clause 1, wherein: the tree structure comprises a root node and one or more subtree structures branching from the root node to a plurality of leaf nodes, the leaf nodes representing at least some of the sequence of tensors; and each subtree structure comprises a parent node at a higher level of the tree structure and one or more child nodes at a lower level of the tree structure.
Clause 3: The processor-implemented method of Clause 2, wherein the sequence of tensors is the child nodes at a bottommost level of the tree structure.
Clause 4: The processor-implemented method of Clause 2 or 3, wherein the parent node is a virtual node.
Clause 5: The processor-implemented method of Clause 2 or 3, wherein the parent node is a tensor in the sequence of tensors.
Clause 6: The processor-implemented method of any of Clauses 2 to 5, wherein each node in the tree structure is associated with a self-term, a first interaction term indicating a child-to-parent relationship for the node, a second interaction term indicating a parent-to-child relationship for the node, and input features of the node.
Clause 7: The processor-implemented method of Clause 6, wherein the self-term, the first interaction term, and the second interaction term are included in the tree matrix, for each node.
Clause 8: The processor-implemented method of any of Clauses 2 to 7, wherein: effectively accessing the tree matrix comprises propagating first information associated with each leaf node of the tree structure towards the root node of the rooted tree structure; and effectively matrix multiplying the inverse of the tree matrix with the sequence of tensors comprises solving for the state variables by propagating second information associated with the root node towards the plurality of leaf nodes of the tree structure.
Clause 9: The processor-implemented method of any of Clauses 1 to 8, wherein the tree structure captures correlations among non-adjacent tensors in the sequence.
Clause 10: The processor-implemented method of any of Clauses 1 to 9, wherein the tree structure is capable of capturing a correlation between an initial tensor in the sequence and a last tensor in the sequence.
Clause 11: The processor-implemented method of any of Clauses 1 to 10, wherein the tree matrix is a sparse matrix compared to the inverse of the tree matrix.
Clause 12: The processor-implemented method of any of Clauses 1 to 11, wherein the input is a point cloud or an image and wherein the taking one or more actions comprises detecting one or more objects in the point cloud or the image, classifying one or more objects in the point cloud or the image, or performing facial recognition on the image.
Clause 13: The processor-implemented method of any of Clauses 1 to 12, wherein the processing comprises processing the state variables with a machine learning model.
Clause 14: The processor-implemented method of any of Clauses 1 to 13, wherein the processing comprises generating a next state based upon the state variables.
Clause 15: The processor-implemented method of any of Clauses 1 to 14, wherein the input is an input prompt and wherein the processing comprises generating a text response to the input prompt.
Clause 16: The processor-implemented method of any of Clauses 1 to 15, wherein taking the one or more actions comprises at least one of generating or providing an output based upon content of the processed state variables.
Clause 17: The processor-implemented method of any of Clauses 1 to 16, wherein the tree structure was constructed using a breadth-first search, a depth-first search, random assignment, learned or adaptive grouping, or domain-specific strategies.
Clause 18: A processing system comprising: at least one memory comprising computer-executable instructions; and one or more processors coupled to the at least one memory and collectively configured to execute the computer-executable instructions and cause the processing system to perform a method in accordance with any of Clauses 1 through 17.
Clause 19: A mobile device comprising the processing system of Clause 18.
Clause 20: A processing system comprising means for performing a method in accordance with any of Clauses 1 through 17.
Clause 21: A non-transitory computer-readable medium comprising computer-executable instructions that, when executed by one or more processors of a processing system, cause the processing system to perform a method in accordance with any of Clauses 1 through 17.
Clause 22: A computer program product embodied on a computer-readable storage medium comprising code for performing a method in accordance with any of Clauses 1 through 17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced, using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A processing system comprising:
at least one memory comprising computer-executable instructions; and
one or more processors coupled to the at least one memory and collectively configured to execute the computer-executable instructions and cause the processing system to:
scan an input to generate a sequence of tensors representing features of the input;
effectively access a tree matrix representing a trained tree structure corresponding to the sequence of tensors, the tree structure including at least two hierarchical levels;
effectively matrix multiply an inverse of the tree matrix with the sequence of tensors to generate state variables according to a state space model;
process the state variables; and
take one or more actions based on the processed state variables.

2. The processing system of claim 1, wherein:
the tree structure comprises a root node and one or more subtree structures branching from the root node to a plurality of leaf nodes, the leaf nodes representing at least some of the sequence of tensors; and
each subtree structure comprises a parent node at a higher level of the tree structure and one or more child nodes at a lower level of the tree structure.

3. The processing system of claim 2, wherein the sequence of tensors is the child nodes at a bottommost level of the tree structure.

4. The processing system of claim 2, wherein the parent node is a virtual node.

5. The processing system of claim 2, wherein the parent node is a tensor in the sequence of tensors.

6. The processing system of claim 2, wherein each node in the tree structure is associated with a self-term, a first interaction term indicating a child-to-parent relationship for the node, a second interaction term indicating a parent-to-child relationship for the node, and input features of the node.

7. The processing system of claim 6, wherein the self-term, the first interaction term, and the second interaction term are included in the tree matrix, for each node.

8. The processing system of claim 2, wherein:
to effectively access the tree matrix, the one or more processors are configured to execute the computer-executable instructions and cause the processing system to propagate first information associated with each leaf node of the tree structure towards the root node of the tree structure; and
to effectively matrix multiply the inverse of the tree matrix with the sequence of tensors, the one or more processors are configured to execute the computer-executable instructions and cause the processing system to solve for the state variables by propagating second information associated with the root node towards the plurality of leaf nodes of the tree structure.

9. The processing system of claim 1, wherein the tree structure captures correlations among non-adjacent tensors in the sequence.

10. The processing system of claim 1, wherein the tree structure is capable of capturing a correlation between an initial tensor in the sequence and a last tensor in the sequence.

11. The processing system of claim 1, wherein the tree matrix is a sparse matrix compared to the inverse of the tree matrix.

12. The processing system of claim 1, wherein the input is a point cloud or an image and wherein to take the one or more actions, the one or more processors are configured to execute the computer-executable instructions and cause the processing system to detect one or more objects in the point cloud or the image, classify one or more objects in the point cloud or the image, or perform facial recognition on the image.

13. The processing system of claim 1, wherein to process the state variables, the one or more processors are configured to execute the computer-executable instructions and cause the processing system to process the state variables with a machine learning model.

14. A processor-implemented method of machine learning, comprising:
scanning an input to generate a sequence of tensors representing features of the input;
effectively accessing a tree matrix representing a trained tree structure corresponding to the sequence of tensors, the tree structure including at least two hierarchical levels;
effectively matrix multiplying an inverse of the tree matrix with the sequence of tensors to generate state variables according to a state space model;
processing the state variables; and
taking one or more actions based on the processed state variables.

15. The processor-implemented method of claim 14, wherein:
the tree structure comprises a root node and one or more subtree structures branching from the root node to a plurality of leaf nodes, the leaf nodes representing at least some of the sequence of tensors; and
each subtree structure comprises a parent node at a higher level of the tree structure and one or more child nodes at a lower level of the tree structure.

16. The processor-implemented method of claim 15, wherein the sequence of tensors is the child nodes at a bottommost level of the tree structure.

17. The processor-implemented method of claim 15, wherein the parent node is a virtual node.

18. The processor-implemented method of claim 15, wherein the parent node is a tensor in the sequence of tensors.

19. The processor-implemented method of claim 15, wherein each node in the tree structure is associated with a self-term, a first interaction term indicating a child-to-parent relationship for the node, a second interaction term indicating a parent-to-child relationship for the node, and input features of the node.

20. The processor-implemented method of claim 19, wherein the self-term, the first interaction term, and the second interaction term are included in the tree matrix, for each node.

21. The processor-implemented method of claim 15, wherein:
effectively accessing the tree matrix comprises propagating first information associated with each leaf node of the tree structure towards the root node of the tree structure; and
effectively matrix multiplying the inverse of the tree matrix with the sequence of tensors comprises solving for the state variables by propagating second information associated with the root node towards the plurality of leaf nodes of the tree structure.

22. The processor-implemented method of claim 14, wherein the tree structure captures correlations among non-adjacent tensors in the sequence.

23. The processor-implemented method of claim 14, wherein the tree structure is capable of capturing a correlation between an initial tensor in the sequence and a last tensor in the sequence.

24. The processor-implemented method of claim 14, wherein the tree matrix is a sparse matrix compared to the inverse of the tree matrix.

25. The processor-implemented method of claim 14, wherein the input is a point cloud or an image and wherein taking the one or more actions comprises detecting one or more objects in the point cloud or the image, classifying one or more objects in the point cloud or the image, or performing facial recognition on the image.

26. The processor-implemented method of claim 14, wherein the processing comprises processing the state variables with a machine learning model.

27. A processing system comprising:
means for scanning an input to generate a sequence of tensors representing features of the input;
means for effectively accessing a tree matrix representing a trained tree structure corresponding to the sequence of tensors, the tree structure including at least two hierarchical levels;
means for effectively matrix multiplying an inverse of the tree matrix with the sequence of tensors to generate state variables according to a state space model;
means for processing the state variables; and
means for taking one or more actions based on the processed state variables.
